(19) United States
(12) Patent Application Publication
(10) Pub. No.: US 2013/0080714 A1
(43) Pub. Date: Mar. 28, 2013

(54) I/O MEMORY TRANSLATION UNIT WITH SUPPORT FOR LEGACY DEVICES

(71) Applicants: Andrew G. Kegel, Redmond, WA (US); Stephen D. Glaser, San Francisco, CA (US)

(72) Inventors: Andrew G. Kegel, Redmond, WA (US); Stephen D. Glaser, San Francisco, CA (US)

(21) Appl. No.: 13/247,457

(22) Filed: Sep. 28, 2011

(51) Int. Cl. G06F 12/00; G06F 12/10

(52) U.S. Cl. 711/154; 711/E12.058; 711/E12.001

(57) ABSTRACT

An apparatus, method, and medium are disclosed for managing memory access from I/O devices. The apparatus comprises a memory management unit configured to receive, from an I/O device, a request to perform a memory access operation to a system memory location. The memory management unit is configured to detect that the request omits a memory access parameter, determine a value for the omitted parameter, and cause the memory access to be performed using the determined value.

### BACKGROUND

Many modern computer systems implement memory management functionality for controlling access to system memory. Such functionality may be implemented using one or more memory management units (MMU) configured to control access to memory. For example, a system may include one MMU for regulating access to memory by one or more processors and/or a separate I/O memory management unit (IOMMU) for regulating access to memory by one or more peripheral devices, such as those capable of direct memory access (DMA). An IOMMU is a memory management unit that connects a DMA-capable devices and/or I/O bus to main memory.

Memory management units serve several functions, such as virtual-to-physical address translation and enforcement of access protections. For example, when a device attempts to access memory using a virtual memory address of a virtual address space, the IOMMU may translate the address to a system physical address (SPA) where data for that virtual address is stored. An IOMMU may also enforce various memory protections, such that a device cannot read or write memory that hasn't been explicitly allocated to it.

An IOMMU that receives a memory access request from a peripheral device often relies on various identifiers, flags, and/or other data in the request, to perform the memory access operation. For example, a request may include a device identifier (e.g., Bus/Device/Function number) usable by the IOMMU to identify the requesting device and thereby the specific page tables to use for virtual address translation and/or other access control. A memory access request may include other parameters, such as an no-execute (NX) flag, a privilege level, a flag indicating that various memory is or is not cacheable, the endianness of the memory address, and/or other properties. A device identifier, NX flag, privilege level, and/or any other parameter provided to the IOMMU by a peripheral device as part of a memory access request may be referred to herein generally as a memory access parameter.

### SUMMARY OF EMBODIMENTS

An apparatus, method, and medium are disclosed for managing memory access from I/O devices. The apparatus comprises a memory management unit configured to receive, from an I/O device, a request to perform a memory access operation to a system memory location. The memory management unit is configured to detect that the request omits a memory access parameter, determine a value for the omitted parameter, and cause the memory access to be performed using the determined value.

In some embodiments, the memory access parameter may be usable by the memory management unit to determine a memory address space in which to perform the memory access request. In other embodiments, the memory access parameter may correspond to a permission-level indication, a no-execute flag, an endianness indication, a caching instruction, and/or another parameter. The memory management unit may insert a default value, may read the value from a device table entry, and/or may determine the value to insert in other ways.

### BRIEF DESCRIPTION OF THE DRAWINGS

FIG. 1 is a block diagram illustrating a high-level view of a computer system that includes an IOMMU configured to perform memory access parameter injection, according to some embodiments.

FIG. 2 is a flow diagram illustrating a method for memory access parameter injection, according to some embodiments.

FIG. 3 is a block diagram illustrating various components of a system configured to perform memory access parameter injection, according to some embodiments.

FIG. 4 is a flow diagram illustrating a method for injecting a process identifier into a memory access request, according to some embodiments.

FIG. 5 is a block diagram illustrating a computer system configured to perform memory access parameter injection as described herein, according to some embodiments.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, in a processor having eight processing elements or cores, the terms “first” and “second” processing elements can be used to refer to any two of the eight processing elements. In other words, the “first” and “second” processing elements are not limited to logical processing elements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

An IOMMU that receives a memory access request from a peripheral device often relies on various identifiers, flags, and/or other data in the request, to perform the access operation. Such parameters, referred to herein generally as memory access parameters, may include a device identifier, NX flag, privilege level indication, endianness indications, cacheability indications, and/or other parameters.

Occasionally, legacy peripheral devices may not be configured to provide all of the memory access parameters that are usable by a given IOMMU. For example, in virtualized environments, where a virtual machine monitor (VMM) hosts multiple guest operating systems, memory access requests may specify memory addresses using a guest virtual address (GVA). In such a case, the IOMMU may be configured to perform two levels of translation: a translation from a guest virtual address (GVA) to a guest physical address (GPA), and another translation from the GPA to a system physical address (SPA) where the data is actually stored. An example of such an IOMMU is disclosed in U.S. Patent Publication 2011/0023027, I/O Memory Management Unit Including Multilevel Address Translation for I/O and Computation Offload, which is incorporated by reference herein in its entirety. To enable GVA-to-GPA translation, the IOMMU may require that the request provide a process address space identifier (PASID) usable by the IOMMU to determine additional page tables for performing the GVA-to-GPA translation. However, some legacy devices may not be configured to include a PASID in a memory access request. Similarly, some legacy devices may omit an NX bit, a privilege level indication, and/or other parameters.

According to various embodiments, an IOMMU may be configured to detect that a memory access request received from a legacy device is missing one or more memory access parameters, and in response, to determine values for the missing parameters. The process of determining values for missing memory access parameters may be referred to herein as memory access parameter injection.

In various embodiments, an operating system, guest operating system, virtual machine monitor, hypervisor, and/or other software may configure the IOMMU to inject memory access parameter values for a memory access request from a legacy device. In different circumstances, the particular value that the IOMMU inserts for a given parameter may be fixed, may depend on the identity of the device, and/or may depend on other parameters.

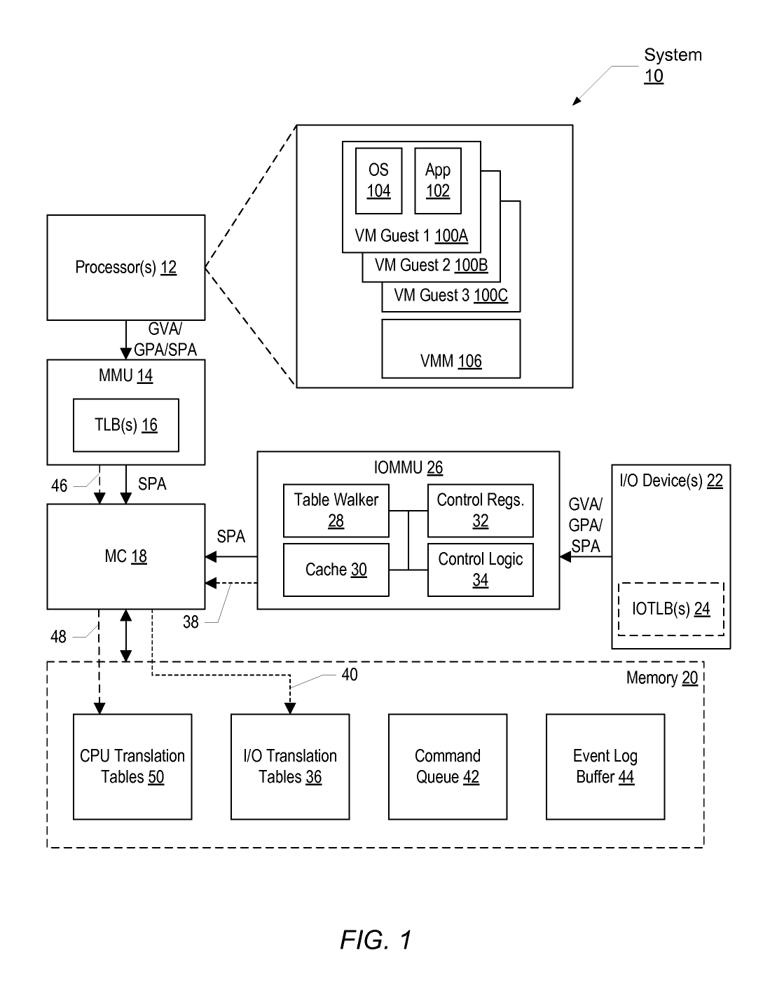

FIG. 1 is a block diagram illustrating a high-level view of a computer system that includes an IOMMU configured to perform memory access parameter injection, according to some embodiments. In the illustrated embodiment, system 10 includes one or more processors 12, a memory management unit (MMU 14), a memory controller (MC 18), memory 20, one or more peripheral I/O devices 22, and IOMMU 26. MMU 14 comprises one or more translation lookaside buffers (TLBs) 16 and peripheral I/O devices 22 comprise one or more I/O TLBs (IOTLBs) 24. According to the illustrated embodiment, I/O MMU (IOMMU) 26 comprises a table walker 28, a cache 30, control registers 32, and control logic 34. Processors 12 are coupled to the MMU 14, which is coupled to the memory controller 18. The I/O devices 22 are coupled to the IOMMU 26, which is coupled to the memory controller 18. Within the IOMMU 26, the table walker 28, the cache 30, the control registers 32, and the control unit 34 are coupled together.

System 10 illustrates high-level functionality of the system; the actual physical implementation may take many forms. For example, the MMU 14 may be integrated into each processor 12 (e.g., each processor may have a separate MMU). Though a memory 20 is shown, the memory system may be a distributed memory system, in some embodiments, in which the memory address space is mapped to multiple, physically separate memories coupled to physically separate memory controllers. The IOMMU 26 may be placed anywhere along the path between I/O-sourced memory requests and the memory 20, and there may be more than one IOMMU. Still further, IOMMUs may be located at different points in different parts of the system.

The processors 12 may comprise any processor hardware, implementing any desired instruction set architecture. In one embodiment, the processors 12 implement the x86 architecture, and more particularly the AMD64™ architecture. Various embodiments may be superpipelined and/or superscalar. Embodiments including more than one processor 12 may be implemented discretely, or as chip multiprocessors (CMP) and/or chip multithreaded (CMT) architectures.

The memory controller 18 may comprise any circuitry designed to interface between the memory 20 and the rest of the system 10. The memory 20 may comprise any semiconductor memory, such as one or more RAMBUS DRAMs (RDRAMs), synchronous DRAMs (SDRAMs), DDR SDRAM, static RAM, etc. The memory 20 may be distributed in a system, and thus there may be multiple memory controllers 18.

The MMU 14 may comprise a memory management unit for memory requests sourced by a processor 12. The MMU may include TLBs 16, as well as table walk functionality. When a translation is performed by the MMU 14, the MMU 14 may generate translation memory requests (e.g. shown as dotted arrows 46 and 48 in FIG. 1) to the CPU translation tables 50. The CPU translation tables 50 may store translation data as defined in the instruction set architecture implemented by the processors 12.

The I/O devices 22 may comprise any devices that communicate between the computer system 10 and other devices, provide human interface to the computer system 10, provide storage (e.g. disk drives, compact disc (CD) or digital video disc (DVD) drives, solid state storage, etc.), and/or provide enhanced functionality to the computer system 10. For example, the I/O devices 22 may comprise one or more of: network interface cards, integrated network interface functionality, modems, video accelerators, audio cards or integrated audio hardware, hard or floppy disk drives or drive controllers, hardware interfacing to user input devices such as keyboard, mouse, tablet, etc., video controllers for video displays, printer interface hardware, bridges to one or more peripheral interfaces such as PCI, PCI express (PCIe), PCI-X, USB, firewire, SCSI (Small Computer Systems Interface), etc., sound cards, and a variety of data acquisition cards such as GPIB or field bus interface cards, etc. The term “peripheral device” may also be used to describe some I/O devices.

In some cases, one or more of the I/O devices 22 may comprise an I/O translation lookaside buffer (IOTLB), such as IOTLBs 24. These IOTLBs may be referred to as “remote IOTLBs”, since they are external to the IOMMU 26. In such cases, the addresses that have already been translated may be marked in some fashion so that the IOMMU 26 does not attempt to translate the memory request again. In one embodiment, the translated addresses may simply be marked as “pretranslated.”

As described further below, the IOMMU 26 may include various features to simplify virtualization in the system 10. The description below will refer to a virtual machine monitor (VMM) that manages the virtual machines (scheduling their execution on the underlying hardware), controls access to various system resources, and/or provides other functions. The term VMM and hypervisor are used interchangeably in this disclosure.

In the illustrated embodiment, processor(s) 12 is configured to execute software in a virtualized environment. Accordingly, FIG. 1 shows three virtual machines 100A, 100B, and 100C (i.e., VM guests 1-3) executing on VMM 106. The number of virtual machines in a given embodiment may vary at different times, and may dynamically change during use as virtual machines are started and stopped by a user. In the illustrated embodiment, the virtual machine 100A includes one or more guest applications 102 and a guest operating system (OS) 104. The OS 104 is referred to as a “guest” OS, since the OS 104 controls the virtual machine created for it by the VMM 106, rather than the physical hardware of the system 10. Similarly, the VM 100B and VM 100C may also each include one or more guest applications and a guest OS.

Applications in a virtual machine use a virtual address space of the virtual machine, and therefore guest virtual addresses (GVAs). The guest OS of the virtual machine may manage settings (e.g., page tables) in IOMMU 26 to enable the IOMMU to map the virtual machine's GVAs to guest physical addresses (GPAs), which are also specific to the same virtual machine. If the guest OS were running directly on the system hardware, with no VMM interposed, the physical addresses that the OS settings generate would indeed be the system physical addresses (SPA) for system 10. However, because the guest OS is running in a virtual machine, it may only provide settings for translation from a guest-specific GVA to a GPA specific to the same guest. Therefore, in some embodiments, the virtual machine monitor (e.g., VMM 106) may manage settings in the IOMMU for mapping GPAs of various guest machines to corresponding SPAs of the underlying system. Thus, if an I/O device 22 performs a memory access request specifying a GVA of guest 100A, the IOMMU 26 may use settings from VMM 106 and guest OS 104 to translate the GVA to an SPA.

As illustrated in FIG. 1, the path from the I/O devices 22 to the memory 20 is at least partially separate from the path of the processors 12 to the memory 20. Specifically, the path from the I/O devices 22 to memory 20 does not pass through the MMU 14, but instead goes through the IOMMU 26. Accordingly, the MMU 14 may not provide memory management for the memory requests sourced from the I/O devices 22.

Generally, memory management may provide address translation and memory protection. Address translation translates a virtual address to a physical address (e.g., a GVA to SPA, as described above). Memory protection functions may control read and/or write access to the memory at some level of granularity (e.g., a page), along with various other memory access parameters, such as privilege level requirements, cacheability and cache controls (e.g., writethrough or writeback), coherency, NX flags, etc. Any set of memory protections may be implemented in various embodiments. In some embodiments, the memory protections implemented by the IOMMU 26 may differ from the memory protections implemented by the MMU 14, in at least some respects. In one embodiment, the memory protections implemented by the IOMMU 26 may be defined so that the translation tables storing the translation data used by the IOMMU 26 and the MMU 14 may be shared (although shown separately in FIG. 1 for ease of discussion). In other embodiments, the translation tables may be separate and not shared between the IOMMU 26 and the MMU 14, to various extents.

I/O devices 22 may be configured to issue memory access requests, such as direct memory access (DMA), address translation services (ATS) access, page request interface (PRI) access, and/or other types of operations to access memory 20. Some operation types may be further divided into subtypes. For example, DMA operations may be read, write, or interlocked operations. Memory access operations may be initiated by software executing on one or more of processors 12. The software may program the I/O devices 22 directly or indirectly to perform the DMA operations.

The software may provide the I/O devices 22 with addresses corresponding to an address space in which the software is executing. For example, a guest application (e.g., App 102) executing on processor 12 may provide an I/O device 22 with GVAs, while a guest OS executing on processor 12 (e.g., OS 104) may provide GPAs to the I/O devices 22.

When I/O device 22 requests a memory access, the guest addresses (GVAs or GPAs) may be translated by the IOMMU 26 to corresponding system physical addresses (SPAs). The IOMMU may present the SPAs to the memory controller 18 for access to memory 20. That is, the IOMMU 26 may modify the memory requests sourced by the I/O devices 22 to change (i.e., translate) the received address in the request to an SPA, and then forward the SPA to the memory controller 18 to access memory 20.

In various embodiments, the IOMMU 26 may provide one-level, two-level, or no translations depending on the type of address it receives from the I/O device. For example, in response to receiving a GPA, the IOMMU 26 may provide a GPA-to-SPA (one-level) translation, and in response to receiving a GVA, the IOMMU 26 may provide a GVA-to-SPA (two-level) translation. Therefore, a guest application may provide GVA addresses directly to an I/O device when requesting memory accesses, thereby making conventional VMM interception and translation unnecessary. Although one-level, two-level, or no translations are described, it is contemplated that in other embodiments, additional address spaces may be used. In such embodiments, additional levels of translation (i.e., multilevel translations) may be performed by IOMMU 26 to accommodate additional address spaces.

The IOMMU 26 illustrated in FIG. 1 may include the table walker 28 to search the I/O translation tables 36 for a translation for a given memory request. The table walker 28 may generate memory requests to read the translation data from the translation tables 36. The translation table reads are illustrated by dotted arrows 38 and 40 in FIG. 1.

To facilitate more rapid translations, the IOMMU 26 may cache some translation data. For example, the cache 30 may be a form of cache similar to a TLB, which caches the result of previous translations, mapping guest virtual and guest physical page numbers to system physical page numbers and corresponding translation data. If a translation is not found in the cache 30 for the given memory request, the table walker 28 may be invoked. In various embodiments, the table walker 28 may be implemented in hardware, in a microcontroller, in other processor and corresponding executable code (e.g. in a read-only memory (ROM) in the IOMMU 26), and/or in other ways. In some embodiments, table walker 28 may be implemented in software as part of VMM 106 and cache 30 could be exposed (i.e., visible, addressable) by the VMM 106 and address translation information would be inserted by software programming running on Processor 12 Other caches may be included to cache page tables, or portions thereof, and/or device tables, or portions thereof, as part of cache 30. Accordingly, the IOMMU 26 may include one or more memories to store translation data that is read from, or derived from, translation data stored in the memory 20.

The control logic 34 may be configured to access the cache 30 to detect a hit/miss of the translation for a given memory request, and may invoke the table walker 28. The control logic 34 may also be configured to modify the memory request from the I/O device with the translated address, and to forward the request upstream toward the memory controller 18.

The control logic 34 may control various other functionalities in the IOMMU 26 as programmed into the control registers 32. For example, the control registers 32 may define an area of memory to be a command queue 42 for memory management software to communicate control commands to the IOMMU 26. The control logic 34 may be configured to read the control commands from the command queue 42 and execute the control commands. Similarly, the control registers 32 may define another area of memory to be an event log buffer 44. The control logic 34 may detect various events and write them to the event log buffer 44. The events may include various errors detected by the control logic 34 with respect to translations and/or other functions of the IOMMU 26. The control logic 34 may also implement other features of the IOMMU 26.

As described above, the IOMMU 26 may employ various data structures, such as one or more sets of I/O translation tables 36 stored in the memory 20. I/O translation tables 36 may be usable to implement one-level and/or two-level translation for memory access requests from I/O devices 22. For example, I/O translation tables 36 may include a first set of page tables for performing GVA-to-GPA translations and a second set for performing GPA-to-SPA translation. The I/O translation tables 36 may store data in any format, including that defined in the x86 and AMD64™ instruction set architectures.

Each memory access request received by the IOMMU from I/O devices may include various memory access parameters. For example, in some embodiments, each request is tagged with a unique device identifier, such as a BDF (or RID), to mark it as coming from the sending device. An IOMMU may use the device identifier of a given request to select a set of page tables 36 that corresponds to that device. In some embodiments, software (e.g., VMM, OS, etc.) may configure the page tables 36 to translate GPAs to SPAs (one-level translation). Thus, the IOMMU can provide one-level translation.

In a virtualized environment such as system 10, IOMMU 26 may be configured to translate GVAs to SPAs (two-level translation). In some embodiments, I/O devices may enable such two-level translation by providing additional memory access parameters. For example, according to the IOMMU (v2) standard, I/O devices may provide a process address space identifier (PASID) as part of a memory access request. The I/O device may provide the PASID as part of a PCI protocol extension, such as the PASID TLP prefix. The IOMMU may use a provided PASID to select a set of GVA-to-GPA page tables for translation. Thus, an I/O device configured to send memory access requests that include a PASID may enable an IOMMU to perform 2-level address translation. In some embodiments, the PASID may be supplied using various other methods.

New peripheral devices may be configured to provide memory access parameters, such as a PASID, when making memory access requests. Traditionally, older legacy peripherals that were unable to provide such parameters could not take advantage of the corresponding IOMMU features. For example, a new peripheral that provided a PASID could use two-layer (GVA-to-SPA) translation while an older peripheral that did not provide the PASID, could not use the two-layer translation. In many cases, older peripheral devices cannot provide various other parameters, such as an NX flag, privilege level indications, endianness indications, cacheability indications, coherency control, and/or other parameters. Accordingly, such peripheral devices could not traditionally leverage other corresponding IOMMU features that these parameters enable.

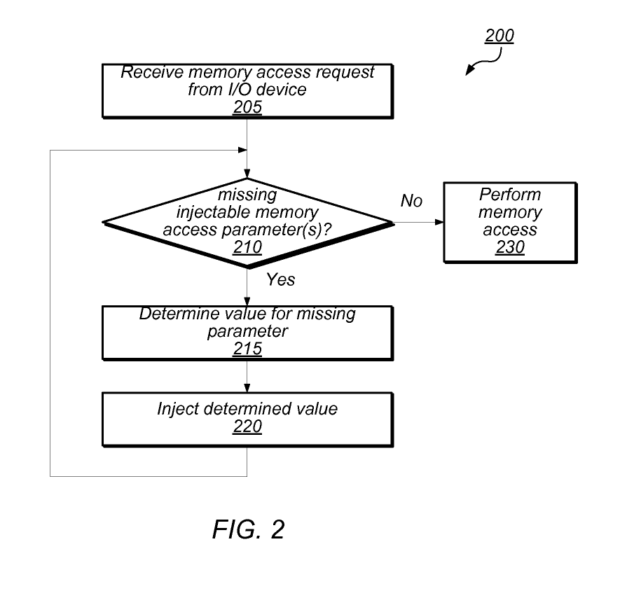

FIG. 2 is a flow diagram illustrating a method for memory access parameter injection, according to some embodiments. The method of FIG. 2 may be performed by an IOMMU, such as IOMMU 26 of FIG. 1.

Method 200 begins when the IOMMU receives a memory request from an I/O device, as in 205. The device may correspond to one of I/O devices 22. If the I/O device is a legacy device, it may not be configured to include various memory access parameters, such as a PASID. For example, a legacy device that is configured to request memory access according to the IOMMU (v1) standard may send requests that do not include a PASID TLP prefix, as defined in the IOMMU (v2) standard. Therefore, a request from such a legacy device may be missing various memory access parameters included in the prefix, such as a PASID, an NX bit, privilege level values, and/or other parameters.

In 210, the IOMMU determines whether the memory access request received in 205 is missing one or more memory access parameters that the IOMMU is configured to inject. For example, in 210, the IOMMU may determine that the request does not include a PASID TLP prefix. In response to determining that such a prefix is missing, the IOMMU may determine whether it should inject a value for one or more of the missing parameters. For example, the IOMMU may determine whether to inject missing values by checking one or more flags corresponding to the peripheral device. In some embodiments, such flags may be implemented in memory (e.g., memory 20), in one or more hardware registers of the IOMMU (e.g., control registers 32), and/or in other parts of the system. In some embodiments, the flags may be managed by software, such as an operating system, a guest operating system, a VMM, or other software.

If the memory access request is not missing any parameters that the IOMMU can inject, as indicated by the negative exit from 210, the IOMMU may perform the memory access, as in 230. In some situations, the IOMMU may determine that it cannot inject any missing parameters into the memory access request because none are missing (e.g., the IOMMU is configured to inject a PASID, but the request already includes one). In other situations, the IOMMU may determine that although the memory access request is missing one or more memory access parameters, the software has configured the IOMMU not inject values for those particular parameters. For example, software may use one or more flags associated with the peripheral device to indicate to the IOMMU not to inject particular parameters. In response to determining that a received memory access request is not missing any injectable memory access parameters (as indicated by the negative exit from 210), the IOMMU may perform the memory access (as in 230).

If the memory access request includes a missing injectable memory access parameter, as indicated by the affirmative exit from 210, the IOMMU may determine a value for the missing parameter, as in 215, and inject the determined parameter into the request, as in 220. The IOMMU may repeat steps 210-220 for each missing memory access parameter, as indicated by the feedback loop from 220 to 210.

The determining step of 215 may vary across embodiments. In some embodiments, the IOMMU may be configured to inject a default value for the given parameter. For example, if the IOMMU receives a memory access request that is missing a PASID, the IOMMU may inject a default value (e.g., 0) as the PASID for the request. In other embodiments, the IOMMU may inject different values for different requests. The choice of injection value may depend on the particular peripheral device from which the memory request came. For example, in some embodiments, the IOMMU may find the appropriate parameter value in a register, memory region, data structure, and/or other field corresponding to the device from which the request came. In one such example, the injection value is stored in a field of a device table entry (DTE) corresponding to the requesting device, where the DTE is an entry of a device table that the IOMMU uses to perform address translation. Such as device table may be stored as one of I/O translation tables 36. In various embodiments, the injection value(s) may be stored in system memory, local memory of the IOMMU, in registers of the IOMMU, and/or elsewhere in the system. In some embodiments, software (e.g., OS, VMM, etc.) may set and/or otherwise manipulate the injection values.

According to method 200, once the IOMMU has injected values for each injectable memory access parameter, the IOMMU may perform the memory access operation, as in 230. In some embodiments, performing the memory access in 230 may comprise translating one or more memory addresses in the request from a GVA or GPA to an SPA and/or enforcing any number of memory restrictions.

In some embodiments, the IOMMU may perform address translation in 230, as described above. For example, IOMMU 26 may utilize control logic 34 and/or table walker 28 to traverse one or more I/O translation tables 36 for determining a translated SPA address for a given GVA address (i.e., two-level translation).

In some circumstances, performing the memory access operation in 230 may include enforcing memory protections. For example, IOMMU may verify that the memory addresses in the received request map to SPAs to which the I/O device has access. Various access permission may be set by software, such as a guest operating system. In some embodiments, verifying that the memory access is within proper memory constraints may depend on one or more privilege level values included in the request and/or privilege level parameters stored in memory and/or on the IOMMU. In some embodiments, the I/O request may include various other access parameters usable to enforce and/or verify memory constraints.

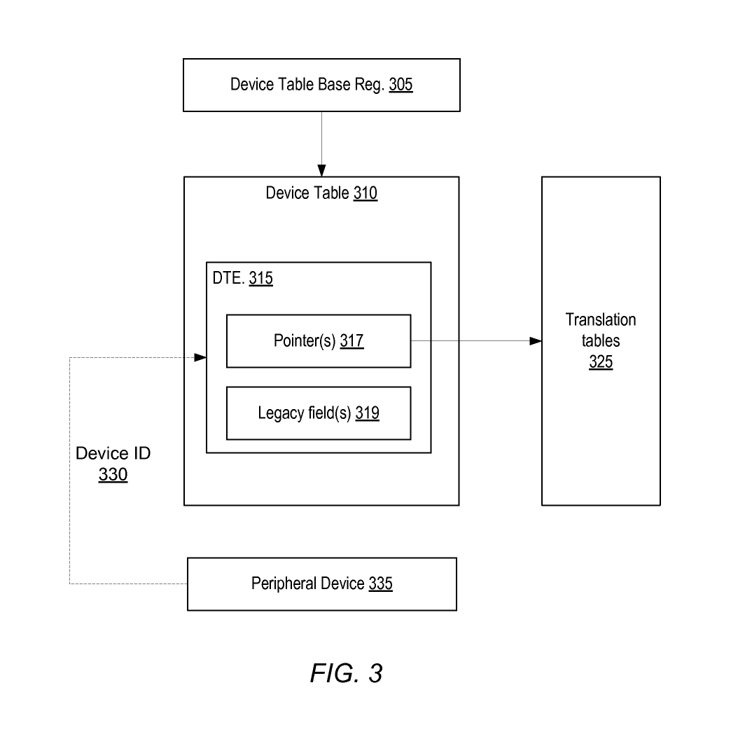

FIG. 3 is a block diagram illustrating various components of a system configured to perform memory access parameter injection, according to some embodiments. Different components in FIG. 3 may correspond to different hardware and/or software components illustrated in FIG. 1, as described below.

To perform memory translation, the IOMMU may require access to various translation tables, such as ones of I/O translation tables 36, which may be stored in memory 20. One such table may be a device table (e.g., 310), which contains a respective entry for each I/O device that can make a memory access request. The IOMMU may be configured to locate the device table using a memory address stored in a device table base register, such as 305. Device table base register 305 may be implemented as one or more of control registers 32, and may be configured to store a memory address where the device table is stored. Thus, when translating a memory address, the IOMMU may locate the device table by reading the table's memory address from base register 305.

In some embodiments, device table 310 may include a respective device table entry (DTE) for each device that is capable of making a memory access request, such as peripheral device 335. For example, device table 310 includes DTE 315, which corresponds to peripheral device 335. Peripheral device 335 may correspond to one of I/O devices 22.

Device table 310 may be indexed by device identifiers, such as BDF numbers. Thus, IOMMU control logic may use a device identifier received as part of a given memory access request, to locate a DTE corresponding to the requesting device. For example, in the illustrated embodiment, peripheral device 335 may include device ID 330 when communicating with the IOMMU. In response to receiving a message from peripheral device 335, the IOMMU may use device ID 330 to locate DTE 315 in device table 310. In different embodiments, the device identifier may be defined in different ways, and may be dependent on the peripheral interconnect to which the device is attached. For example, Peripheral Component Interconnect (PCI) devices may form a device ID from the bus number, device number and function number (BDF or RID) while HyperTransport™ (HT) devices may use a bus number and unit ID to form a device ID.

Each DTE may include one or more pointers (e.g., pointers 317) to a set of translation tables (e.g., 325) that the IOMMU can use to translate memory addresses from the device corresponding to the DTE. The particular number and/or type of pointers 317 and translation tables 325 may vary across embodiments, and may include various translation and/or page tables implementing multi-level translation. For example, one of pointers 317 may point to a page table that is the starting point for translation searching in the translation tables 325. The starting page table may include pointers to other page tables, in a hierarchical fashion. Some tables may be indexed by a process identifier, such as a PASID, while other tables may be indexed using various bits of the address that is to be translated (e.g., GVA or GPA). Thus, the I/O translation tables 325 may support various one or two-level translations.

As illustrated in FIG. 3, DTE 315 includes one or more legacy fields 319. In various embodiments, legacy fields 319 of DTE 315 may include any number of fields, which may include flags and/or other values. These flags and/or values may be set by software to indicate to the IOMMU that the IOMMU should inject various memory access parameters into requests from the peripheral device corresponding to DTE 315 (i.e., peripheral device 335).

A flag of legacy fields 319 may indicate to the IOMMU that the IOMMU should inject one or more default memory access parameters into requests from device 335. For example, in some embodiments, legacy fields 319 may include a PASID flag. If device 335 is a legacy device that is not configured to send a PASID with its requests, software may set the PASID flag to indicate that injection of the PASID parameter is desired. Subsequently, if the IOMMU receives a memory request from device 335, the IOMMU may determine that the request does not include a PASID, extract device ID 330 from the request, use device ID 330 to locate DTE 315, determine that legacy fields 319 of DTE 315 include a PASID flag that is set, and in response, inject a default PASID (e.g., 0) into the request.

In some embodiments, a single flag may indicate that the IOMMU should inject multiple default values for various memory access parameters. For example, if device 335 is a legacy device, it may not be configured to include a PASID TLP prefix altogether. Therefore, in addition to omitting a PASID, requests from device 335 may also omit other parameters, such as an NX bit or privilege-level indicator. In some embodiments, the IOMMU may inject default values for these and/or other parameters in response to determining that the PASID flag is set in DTE 315.

In some embodiments, the IOMMU may be configured to inject different values for requests coming from different devices. For example, legacy fields 319 may include a PASID value rather than a PASID flag. In such embodiments, the IOMMU may determine that a request from device 335 omits a PASID value and in response, inject the PASID value stored in corresponding DTE 315. Software may configure different DTEs to store different PASID values. Thus, the IOMMU may be configured to inject different values into requests from different devices. In some embodiments, legacy fields 319 may include values for one or more other parameters, such as an NX bit, privilege level, endianness, etc.

In some embodiments, techniques may be used to decrease the size of the DTE. For example, in some embodiments, an indirection method may be used such that instead of storing the values of legacy fields directly in each DTE 315, the DTE can contain an index number (e.g., an abbreviated pointer) into a secondary table from which the legacy fields can be extracted. In the embodiment of FIG. 3, each Peripheral Device 335 can have a unique setting of Legacy Fields 319. Using the indirection scheme, only the values in the secondary table are available for use and may be “shared” by multiple Peripheral Devices 335. This may reduce the DTE size because the Legacy Field (index) 319 could be implemented using just a few bits (e.g., 1 to 4 bits). In various embodiments, the secondary table could be stored in memory or could be implemented as part of the Control Regs 32. In an extreme case, a single bit in the DTE may be used to indicate whether the IOMMU should use the legacy field values from a set of control registers in the IOMMU (e.g., control registers 32). In such a case, all devices could use the same set of values for legacy fields. In various embodiments, the contents of the secondary table may be managed by the VMM.

Although only one device table 310 is shown, multiple device tables may be maintained if desired. The device table base address in the control register 32 may be changed to point to other device tables. Furthermore, device tables may be hierarchical, if desired, similar to the page tables described above. There may also be multiple sets of page tables (e.g., one per entry in the device table 310).

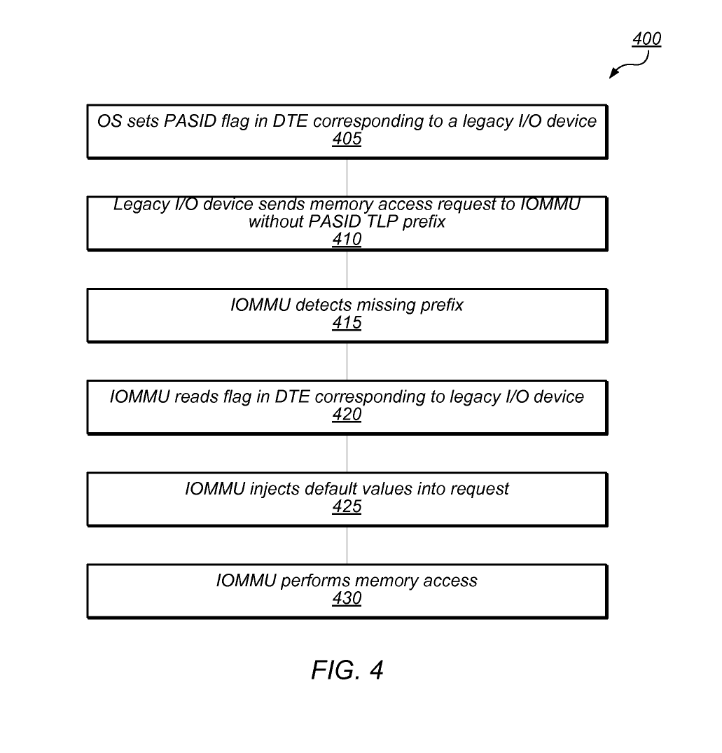

FIG. 4 is a flow diagram illustrating a method for injecting a PASID into a memory access request, according to some embodiments. As indicated in FIG. 4, different steps of method 400 may be performed by different system components, such as software, peripheral devices, and/or the IOMMU.

Method 400 begins when the OS sets a PASID flag in a DTE corresponding to a legacy device, as in 405. In different embodiments, the OS may be a regular operating system or a guest OS, such as OS 104 of FIG. 1. In some virtualized environments, a VMM or other software may set the PASID flag. The set PASID flag may be set to indicate that the IOMMU should inject a default PASID value into requests from the device corresponding to the DTE.

In 410, the legacy I/O device corresponding to the DTE sends a memory access request (e.g., DMA) to the IOMMU, where the access request does not include a PASID TLP prefix. For example, the device may be a legacy device configured to request DMA operations using the IOMMU (v1) standard, which does not include sending a PASID TLP prefix with memory access requests. Therefore, the request is missing various memory access parameters typically specified in the prefix, such as a PASID, NX bit, privilege-level indication, etc. The request may include one or more memory addresses that require translation, such as GVAs.

The IOMMU detects that the request is missing the PASID TLP prefix (415) and in response, reads the PASID flag in the DTE corresponding to the legacy I/O device (420). To read the flag, as in 420, the IOMMU may extract the device identifier (e.g., BDF) from the memory access request and use the identifier to locate a DTE corresponding to the device. Locating the DTE may comprise consulting a device table base register (e.g., 305) to locate an appropriate device table containing the DTE.

In 420, the IOMMU reads the PASID flag in the DTE corresponding to the device. Thus, the IOMMU determines that software has set the flag (i.e., in 405) to indicate that the IOMMU should inject a default value into the request.

In response to determining that the PASID flag of the corresponding DTE is set, the IOMMU injects respective default values for one or more memory access parameters missing from the request, as in 425. For example, since the request is missing a PASID TLP prefix, it does not include a PASID. Therefore, the IOMMU may inject a default PASID value (e.g., 0) into the request in 425. In some embodiments, the IOMMU may also inject a default NX bit, a default privilege level, and/or default values for one or more other parameters of the missing PASID TLP prefix. As described above, in different embodiments, the IOMMU and/or device table may be configured to inject values that are dependent on the particular requesting device.

In 430, the IOMMU performs the memory access. Performing the memory access in 430 may comprise translating one or more memory addresses in the request from a GVA to an SPA and/or enforcing various memory restrictions. For example, the IOMMU may use the injected PASID to navigate any number of translation tables 325 to determine a proper translation from GVA to SPA. In some embodiments, the IOMMU may use a table walker, such as table walker 28, to navigate the translation tables. The IOMMU may also verify in 430 that the translated SPA is within a range of memory to which the peripheral device has previously been granted access.

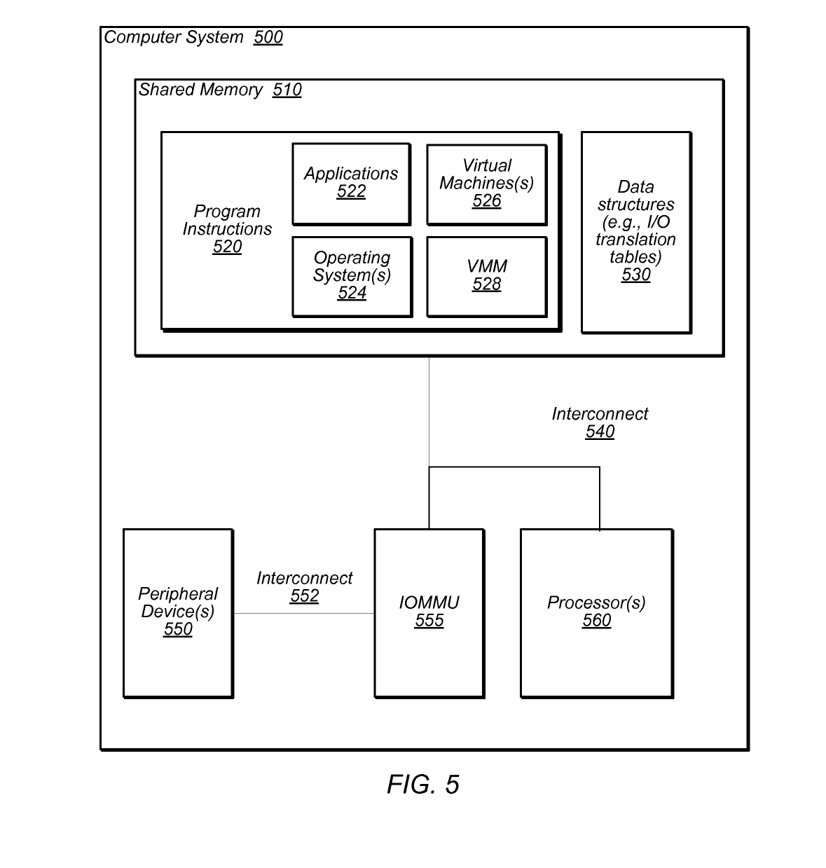

FIG. 5 is a block diagram illustrating a computer system configured to perform memory access parameter injection as described herein, according to some embodiments. The computer system 500 may correspond to any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc, or in general any type of computing device.

Computer system 500 may include one or more processors 560, any of which may include multiple physical and/or logical cores. Any of processors 560 may correspond to processor 12 of FIG. 1 and may be executing VMMs and/or multiple guest operating systems. Computer system 500 may also include one or more peripheral devices 550, which may correspond to I/O devices 22 of FIG. 1, and an IOMMU device 555, as described herein, which may correspond to IOMMU 26 of FIG. 1.

According to the illustrated embodiment, computer system 500 includes one or more shared memories 510 (e.g., one or more of cache, SRAM, DRAM, stacked memory, RDRAM, EDO RAM, DDR 5 RAM, SDRAM, Rambus RAM, EEPROM, etc.), which may be shared between multiple processing cores, such as on one or more of processors 560. In some embodiments, different ones of processors 560 may be configured to access shared memory 510 with different latencies and/or bandwidth characteristics. Some or all of memory 510 may correspond to memory 20 of FIG. 1.

The one or more processors 560, IOMMU 555, and shared memory 510 may be coupled via Interconnect 540. The Peripheral Device(s) 550 may connect to the IOMMU 555 via Interconnect 541. In various embodiments, the system may include fewer or additional components not illustrated in FIG. 5. Additionally, different components illustrated in FIG. 5 may be combined or separated further into additional components.

In some embodiments, shared memory 510 may store program instructions 520, which may be encoded in platform native binary, any interpreted language such as Java™ byte-code, or in any other language such as C/C++, Java™, etc. or in any combination thereof. Program instructions 520 include program instructions to implement software, such as a VMM 528, any number of virtual machines 526, any number of guest operating systems 524, and any number of guest applications 522 configured to execute on the guest OSs 524. Any of software 522-528 may be single or multi-threaded. In various embodiments, OS 524 and/or VMM 528 may configure IOMMU 555 to inject memory access parameters for requests from ones of peripheral devices 550.

According to the illustrated embodiment, shared memory 510 includes data structures 530, which may be accessed by ones of processors 560 and/or by ones of peripheral devices 550 via IOMMU 555 (using interconnect 552). Data structures 530 may include various I/O translation tables, such as 325 in FIGS. 3 and 36 in FIG. 1. Ones of processors 560 may cache various components of shared data 530 in local caches and coordinate the data in these caches by exchanging messages according to a cache coherence protocol.

Program instructions 520, such as those used to implement software 522-528 may be stored on a computer-readable storage medium. A computer-readable storage medium may include any mechanism for storing information in a form (e.g., software, processing application) readable by a machine (e.g., a computer). The computer-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions.

A computer-readable storage medium as described above may be used in some embodiments to store instructions read by a program and used, directly or indirectly, to fabricate hardware comprising one or more of processors 550. For example, the instructions may describe one or more data structures describing a behavioral-level or register-transfer level (RTL) description of the hardware functionality in a high level design language (HDL) such as Verilog or VHDL. The description may be read by a synthesis tool, which may synthesize the description to produce a netlist. The netlist may comprise a set of gates (e.g., defined in a synthesis library), which represent the functionality of processor 500. The netlist may then be placed and routed to produce a data set describing geometric shapes to be applied to masks. The masks may then be used in various semiconductor fabrication steps to produce a semiconductor circuit or circuits corresponding to processors 50 and/or 550. Alternatively, the database may be the netlist (with or without the synthesis library) or the data set, as desired.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed:

1. An apparatus comprising:
a memory management unit configured to receive, from an I/O device, a request to perform a memory access operation to a system memory location;
wherein the memory management unit is configured to detect that the request omits a memory access parameter, determine a value for the omitted parameter, and cause the memory access to be performed using the determined value.

2. The apparatus of claim 1, wherein the memory access parameter is usable by the memory management unit, at least in part, to determine a memory address space in which to perform the memory access request.

3. The apparatus of claim 2, wherein the memory management unit comprises a table walker configured to determine the memory address space by using the memory access parameter to locate a translation table from among a plurality of I/O translation tables.

4. The apparatus of claim 1, wherein the memory management unit is configured to determine the value for the memory access parameter in further response to reading a field of a device table entry corresponding to the I/O device.

5. The apparatus of claim 4, wherein the memory management unit determines a default value for the memory access parameter.

6. The apparatus of claim 4, wherein the memory management unit determines the value for the memory access parameter in response to reading the value from the device table entry.

7. The apparatus of claim 4, wherein the device table entry comprises a pointer to at least one of a set of I/O translation tables usable to translate a memory address indicated by the request to a system physical memory address.

8. The apparatus of claim 4, wherein the memory management unit is configured to determine the device table entry using a bus/device/function number of the I/O device.

9. The apparatus of claim 1, wherein performing the memory access operation comprises translating a guest virtual address indicated by the request to a system physical address.

10. The apparatus of claim 1, wherein the parameter corresponds to a permission-level indication, a no-execute flag, an endianness indication, or a caching instruction indication.

11. A computer-implemented method comprising:
a memory management unit receiving a request, from an I/O device, to perform a memory access operation to a system memory location;
in response to detecting that the request omits a memory access parameter, the memory management unit:
determining a value for the omitted parameter; and
causing the memory access to be performed using the determined value for the memory access parameter.

12. The method of claim 11, wherein the memory access parameter is usable by the memory management unit, at least in part, to determine a memory address space in which to perform the memory access request.

13. The method of claim 12, further comprising a table walker of the memory management unit determining the memory address space by using the memory access parameter to locate a translation table from among a plurality of I/O translation tables.

14. The method of claim 11, further comprising determining the value for the memory access parameter in further response to reading a field of a device table entry corresponding to the I/O device.

15. The method of claim 14, further comprising: determining the value for the memory access parameter in response to reading the value from the device table entry.

16. The method of claim 14, wherein the device table entry comprises a pointer to at least one of a set of I/O translation tables usable to translate a memory address indicated by the request to a system physical memory address.

17. The method of claim 11, wherein performing the memory access operation comprises translating a guest virtual address indicated by the request to a system physical address.

18. The method of claim 11, wherein the parameter corresponds to a permission-level indication, a no-execute flag, an endianness indication, or a caching instruction indication.

19. A computer readable storage medium comprising a data structure which is operated upon by a program executable on a computer system, the program operating on the data structure to perform a portion of a process to fabricate an integrated circuit including circuitry described by the data structure, the circuitry described in the data structure including:
a memory management unit configured to receive, from an I/O device, a request to perform a memory access operation to a system memory location;
wherein the memory management unit is configured to detect that the request omits a memory access parameter, determine a value for the omitted parameter, and cause the memory access to be performed using the determined value.

20. The computer readable storage medium of 19, wherein the storage medium stores HDL, Verilog, or GDSII data.
